(19) United States
(12) Patent Application Publication
(10) Pub. No.: US 2014/0129479 A1
(43) Pub. Date: May 8, 2014

(54) METHOD TO AID IN THE EXPLORATION, MINE DESIGN, EVALUATION AND/OR EXTRACTION OF METALLIFEROUS MINERAL AND/OR DIAMOND DEPOSITS

(71) Applicants: Michael Robert Warner, Surrey (GB); Ivan Stekl, Chatham (GB); Adrian Paul Umpleby, Cambridge (GB)

(72) Inventors: Michael Robert Warner, Surrey (GB); Ivan Stekl, Chatham (GB); Adrian Paul Umpleby, Cambridge (GB)

(73) Assignee: Imperial Innovations Limited, London, Greater London (GB)

(21) Appl. No.: 14/122,222

(22) PCT Filed: May 23, 2012
(86) PCT No.: PCT/GB2012/000459

§ 371 Date: Jan. 8, 2014

(30) Foreign Application Priority Data
May 23, 2011 (GB) 1108671.7

(51) Int. Cl. G06Q 50/02; G06Q 10/06

(52) U.S. Cl. CPC G06Q 50/02; G06Q 10/067
USPC 705/348

(57) ABSTRACT

A method to aid in the exploration, mine design, evaluation and/or extraction of metalliferous mineral and/or diamond deposits in a subsurface, the method comprising: providing three-dimensional seismic data acquired in a seismic survey of the subsurface; providing an initial model of the subsurface; performing wavefield tomography at least partly as a function of at least one property of the subsurface in three-dimensions using the initial model and the seismic data to generate an updated model; and determining an estimate of the at least one property of the subsurface from the updated model.

### BACKGROUND OF THE INVENTION

1. Field of the Invention

The present invention relates to a technique to aid in the exploration, mine design, evaluation and/or extraction of metalliferous mineral and/or diamond deposits in a subsurface, in particular to a technique using seismic surveying for that purpose.

2. Description of the Related Art

Seismic exploration has been used in the search and exploitation of hydrocarbon deposits. Surveys have been conducted both on land and in water and involve surveying subterranean geological formations. This is done by recording at least one seismic source (e.g. acoustic/sonic) using at least one seismic sensor. The seismic source does not need to be man-made or at an accurately known location. Natural or (more likely) induced seismic events may be used as passive sources. The passage of elastic energy in the form of seismic waves from the source to the sensor is effected by geological formations. Therefore information received at the sensor contains information regarding the geological formations which have effected the seismic wave on its passage from the source to the sensor. For example, geological formations can reflect seismic waves. The data received by the sensor is conditioned and processed to generate seismic data along with information regarding the source(s) and the location of the source(s) and sensor(s). The seismic data may be analysed to determine the likelihood of the presence and location of hydrocarbon deposits.

A technique which has been used for analysing seismic data is wavefield tomography (sometimes referred to as waveform tomography, wavefield inversion or waveform inversion).

For mining applications, in particular for mining minerals other than hydrocarbons (for example non-carbonaceous minerals, and/or metalliferous and/or diamond deposits, and/or minerals excluding petroleum and/or excluding coal and/or excluding coalbed methane) post-recognisance high-resolution exploration and evaluation is usually limited to the drilling of bore holes and analysis of extracted cores. This has been in part due to the more accessible nature of sites of interest which are usually on land (as opposed to under the sea) and which deposits must not be found too deep so as otherwise to hamper extraction and because of the need for a higher resolution of the information regarding various deposits and because of the necessity to evaluate the grade of the ore to be extracted. For such tasks, three-dimensional full-wavefield seismic tomography has not been considered.

### SUMMARY OF INVENTION

The present invention provides a method to aid in the exploration, mine design, evaluation and/or extraction of metalliferous mineral and/or diamond deposits in a subsurface, the method comprising:
providing three-dimensional seismic data acquired in a seismic survey of the subsurface;
providing an initial model of the subsurface;
performing wavefield tomography at least partly as a function of at least one property of the subsurface in three-dimensions using the initial model and the seismic data to generate an updated model; and
determining an estimate of the at least one property of the subsurface from the updated model.

The advantage of using this 3D full wavefield seismic tomographic technique is not only the location of the deposits but also physical properties of the deposits, adjacent, overlying and underlying rock units can be estimated at a higher resolution in three dimensions than is realistically possible with drilling alone and 2D seismics and other geophysical methods. Additionally, making the estimate of at least one property of the subsurface may be less expensive using the invention than a borehole survey. This is because the generation of seismic data may be significantly less expensive than the generation of multiple boreholes.

Additionally, the present invention may be an adjunct to the drilling of bore holes. Fewer drill holes may be required, and/or the technique may provide additional information about physical properties that it is not possible to determine from drill holes and cores.

The technique of the present invention may be faster than drilling to establish a model of the structure of the subsurface.

The technique of the present invention is more easily repeatable than drilling—e.g. as a mine is developed, to monitor changes in the sub-surface.

The technique of the present invention will often be less invasive, and have a smaller environmental footprint than drilling.

Additionally, the technique of the present invention can be used where physical access, environmental, safety, legal or other issues limit physical drilling.

Additionally, the technique of the present invention can be used where drilling provides a particular environmental hazard as a consequence of the material extracted e.g. poisonous and/or radio-active deposits.

Additionally, the technique of the present invention can be used when drilling may potentially damage ground-water systems e.g. by changing ground water flow/pressure and/or changing chemistry/poisoning ground water.

The wavefield tomography is performed to estimate at least one property of the subsurface in three dimensions. This allows the initial model to be optimised according to the property which is of interest, allowing a more accurate estimate of that property to be made than is present in the initial model.

In an aspect there is provided a method of collecting seismic data, comprising using a plurality of receivers to record seismic waves resulting from explosions used in block caving to build a block caving mine. This way of collecting seismic data is particularly efficient as the explosions used as sources have the dual functionality of both building the mine and excavating deposit as well as generating seismic data. Preferably the seismic data is used in a method to aid in the exploration, mine design, evaluation, and or extraction of metalliferous mineral and/or diamond deposits in a subsurface by using the seismic data in wavefield tomography along with an initial model to generate an updated model; and determining an estimate of at least one property of the subsurface from the updated model.

In an aspect there is provided as computing apparatus to perform the method as well as computer program to perform the method.

### BRIEF DESCRIPTION OF THE DRAWINGS

The invention may be understood by reference to the following description taken in conjunction with the accompanying drawings, in which like reference numerals identify like elements, and in which:

FIG. 1 depicts schematically, in cross-section, how a seismic survey may be conducted in a subsurface;

FIG. 2 depicts schematically the method of the present invention;

FIG. 3 illustrates how a cavity and/or a non-planar top surface of a subsurface may be treated.

### DETAILED DESCRIPTION OF THE INVENTION

In mining applications it is useful to be able to predict the location and mechanical properties of a subsurface (e.g. a section of the earth), particularly of parts of the earth which are capable of trapping deposits of interest.

Deposits of interest may include metalliferous mineral and/or diamond deposits and/or non carbonaceous minerals, that is, deposits excluding petroleum and/or excluding coal and/or excluding coalbed methane).

Knowledge of properties of the subsurface may be useful in exploration (i.e. deciding where suitable deposits may lie), in mine design (e.g. in deciding upon the structure of the mine), in evaluation (for instance in estimating the quality of a deposit) and/or extraction (e.g. in helping decide where and the size of explosives to be placed during extraction of deposits). The present invention is directed at a method which can aid in those activities.

The present invention is also directed to a method of exploration for metalliferous mineral and/or diamond deposits, a method of metalliferous mineral and/or diamond mine design, a method of evaluation of metalliferous mineral and/or diamond deposits and/or a method of extraction of metalliferous mineral and/or diamond deposits in a subsurface.

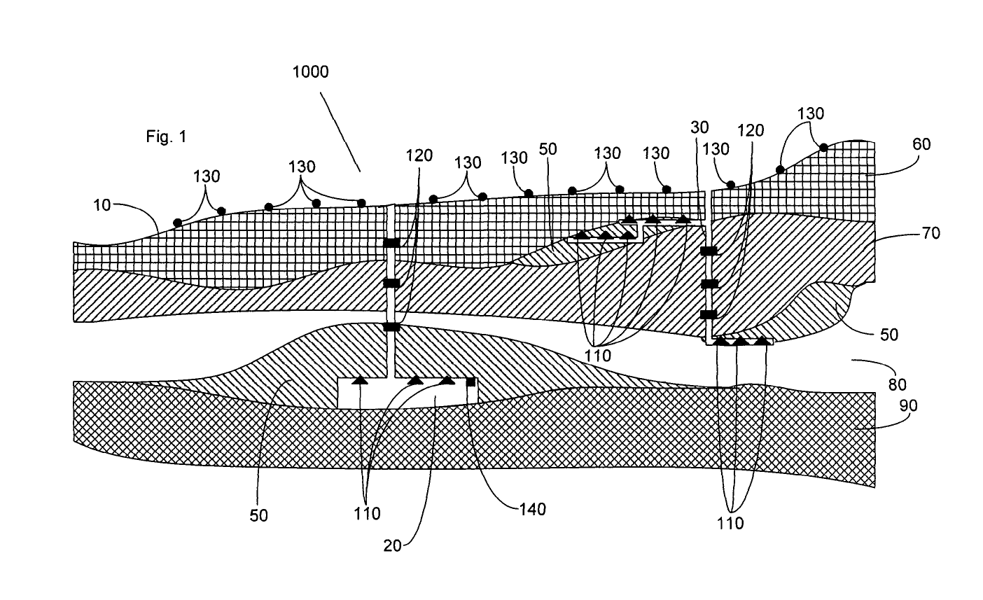

The method of the invention will be described with reference to FIG. 1 which is a cross-section through a subsurface 1000 which contains as a geological formation deposits 50 (for example metalliferous mineral and/or diamond deposits) shown in diagonal cross-hatching from top left to bottom right, as illustrated.

In block cave mining (a block cave mine is shown as 20 in FIG. 1) ore of the deposit is allowed to collapse due to its own weight under gravity in a controlled fashion. Block caving is usually used to mine large ore bodies that are deeply buried, and that have significant vertical extent in comparison to their horizontal extent. Explosives are sometimes used in underground block caving and detailed information regarding not only the location of the ore but also its mechanical properties and/or the mechanical properties of surrounding regions, is extremely useful. In block caving, the mine is engineered so that the ore body collapses from below in a controlled fashion. Potential problems are that the ore body fails to collapse at all, that collapse ceases at some point during extraction of the ore, that the collapse proceeds in unforeseen directions, or at an unforeseen rate, and especially that it proceeds outside the desired ore body and/or proceeds rapidly to the surface, and/or that the fractured ore produced by the collapse is not of an optimal size for subsequent processing being either too large or too fine to handle easily within the mine. These potential problems can have safety and environmental as well as economic consequences. A detailed knowledge of the physical structure of the subsurface, and its detailed mechanical properties, in three dimensions, is required in order to be able to predict with confidence how a block cave will form and evolve as the ore is produced. Such knowledge is therefore important in mine design, in mine operations, and in evaluation of a potential mine site.

For a deep mine such as that illustrated in FIG. 1 and labelled 30, properties of the deposit of interest may include the location of the deposit such that decisions regarding at which levels and in which directions to extend galleries from a main shaft can be made. Information regarding the mechanical properties of the deposit 50 and/or of other geological formations 60, 70, 80, 90 (which are not be mined) may also be of interest. Such information may be useful in determining the likely strength of galleries and thereby may be used in mine design, evaluation and/or actual extraction of deposits.

The present invention uses seismic surveying techniques to survey the subsurface and thereby determine an estimate of at least one property of the subsurface. The property of the subsurface may be a property of any one of the geological formations 50, 60, 70, 80 and 90.

The property may be a property at a particular location irrespective of the type of geological formation 50, 60, 70, 80 and 90. The property of interest is desirably a property of the deposit 50.

Examples of properties of the subsurface which may be estimated are the location of deposits and other geological formations within the subsurface, the mechanical, elastic, anelastic and anisotropic properties of deposits and other geological formations within the subsurface, the intensity, scale, orientation and detailed character and geometry of fracturing, faulting, jointing, micro-cracking, folding, lineation, foliation, lamination, layering, bedding and heterogeneity of deposits and other geological formations within the subsurface, and the density, porosity, pore geometry, fluid content, fluid pressure, mineral alignment, mineral orientation, and state of stress of deposits and other geological formations within the subsurface. Any combination of the above properties may be determined.

This information may be used in exploration and evaluation where possible sites for mining are being investigated, in mine design, for example in determining the shape of the mine and/or where explosives might best be positioned, particularly during block cave mining, in the evaluation of an existing mine, for example how best to expand the mine, and in the actual extraction of the deposit (for example what techniques to use/where to place explosives).

For applications of seismic surveys in mining, a high resolution is required. For example, a higher resolution than is used in petroleum exploration is desired and in particular knowledge of physical properties, for example mechanical properties of the geological formations 50, 60, 70, 80, 90 in the subsurface as well as their location are desired. Properties deducible from seismic survey data may be related to the desired mechanical property.

As with seismic surveys for hydrocarbon deposits, one or more sources 130 of seismic waves and one or more receivers 130 of seismic waves (for example sensors sensitive to pressure changes (hydrophones) and/or sensors sensitive to particle motion (e.g. geophones and/or accelerometers)) may be deployed on or near the top surface 10 of the subsurface 1. In this arrangement the seismic survey relies on reflection, diffraction and back-scattering of seismic energy from interfaces between geological formations 50, 60, 70, 80, 90, and upon the refraction, diffraction and forward scattering of seismic energy within as well as between geological formations 50, 60, 70, 80, 90.

Preferably the three-dimensional seismic data is generated by at least one source and/or at least one receiver in the subsurface. During seismic surveying for hydrocarbon deposits, usually the sources and receivers are positioned on or at the surface of the subsurface, or within the water column or on the seabed of a marine survey. Placing sources and/or receivers underground in the subsurface is possible inexpensively in mining applications, particularly when subsurfaces at or in proximity to existing mines are of interest. In an existing mine it is relatively easy and cheap to place sources and/or receivers within the mine and thereby in the subsurface. The placing of sources and/or receivers in the subsurface leads to greater obtainable resolution, particularly near to geological formations which may be of interest (e.g. deposits).

Sources 120 and/or sensors 120 may be placed vertically in a one dimensional array in a bore hole(s) or shaft(s) of a mine under the subsurface 1000. This can help in increasing the resolution of the seismic survey. In mining applications at least one source/sensor 120 may be positioned in a vertical shaft of a mine, thereby doing away with the need for drilling of a specific bore hole.

Preferably a plurality of sources and/or plurality of receivers are in a multi-dimensional array in the subsurface. This is not possible to achieve with a single borehole and mines are particularly suited to the arrangement of a plurality of sources and/or plurality of receivers in a multi-dimensional array. This further improves the achievable resolution even further over a one-dimensional array in the subsurface. In the case of a mine, it may be possible to arrange the multi-dimensional array substantially in a plane. This has both geometrical advantages in terms of the achievable resolution as a result as well as computational advantages in terms of efficient wavefield tomography in terms of grid generation and/or computation.

Sensors and/or sources 110 may be placed in a substantially horizontal array in a gallery of a mine. Preferably sensors/sources 110 in a gallery of a mine are positioned in a multi dimensional (e.g. two or three dimensional) array in the subsurface 1000. This increases the achievable resolution compared to the case of sensors and/or sources positioned in a one dimensional array in the subsurface 1000. Providing the sources/sensors in a two dimensional array substantially in a plane makes modelling during the below described wavefield tomography easier to implement. A seismic survey may include data from any combination of locations described above. Each location may have exclusively sources, may have exclusively receivers or may have a combination of sources and receivers. Each location described 110, 120, 130 (and 140 below) may have no source, may have no receiver or may have one or more sources or one or more receivers.

During a seismic survey seismic energy is released into the subsurface 1000 through sources. Seismic waves (compressional (P) waves and/or shear (S) waves) pass from the source(s) through the geological formations 50, 60, 70, 80, 90 and/or are reflected and/or refracted and/or diffracted and/or scattered and/or absorbed by the geological formations 50, 60, 70, 80, 90 in a path to a sensor. In response to detected seismic events, the sensor(s) generate electrical signals indicative of the seismic events. These signals form part of the seismic data acquired in the seismic survey. The seismic data also includes information regarding the position of the sensors and sources and additionally information regarding the seismic energy released by the sources.

Analysis of the seismic data as described below, can provide an estimate of at least one property of a deposit 50 and/or a geological formation 60, 70, 80, 90 which is not to be mined. The property may relate to the location of geological formations 60, 70, 80, 90 or deposit 50, or mechanical properties of the geological formation 60, 70, 80, 90 or deposit 50. A mechanical property may be information regarding fractures in the geological formation 60, 70, 80, 90 or deposit 50 as described above.

In one embodiment a seismic source 140 may be an explosion used in the block caving process. This allows seismic surveys to be carried out economically because the source of the seismic energy is being provided for another purpose thereby improving efficiency. Additionally, the position of the source close to the geological formation 60, 70, 80, 90 or deposit 50 of interest helps achieve high resolution.

Because multiple sources or receivers have been used, arranged in a multi-dimensional array, the results of the seismic survey are a three-dimensional seismic data.

Estimates of at least one property of the deposit 50 can be made from actual seismic data by using the technique of wavefield tomography (sometimes called waveform tomography, wavefield inversion or waveform inversion).

Wavefield tomography refers to the derivation of one or more properties of the subsurface 1000 from the three dimensional actual seismic data. This is achieved by modelling the passage of the seismic energy emitted by the sources in a seismic survey and varying parameters of a model of the subsurface 1000 until a good fit between a synthetic seismic data generated by the modelling predicted to be received at the positions of sensors closely matches that of the actual seismic energy received by sensors in the actual seismic data.

Parameters of the model of the subsurface 1000 describe the positions of geological formations 50, 60, 70, 80, 90 by way of their varying properties (primarily velocity of seismic energy through them). After each comparison between synthetic seismic data and actual seismic data, the model is changed in an iterative process until a good fit (for example as determined by a least squares analysis) is achieved between the actual and the synthetic seismic data.

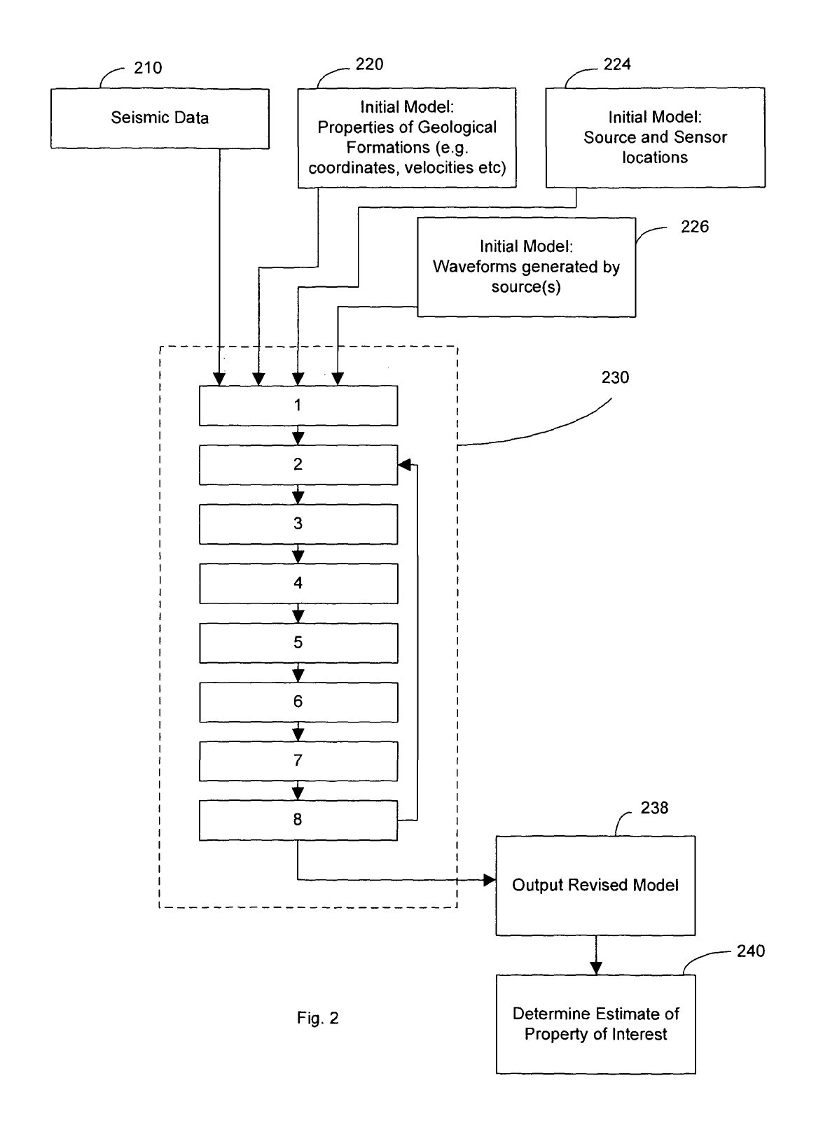

FIG. 2 is a schematic flow chart illustrating how a wavefield tomography step 230 is incorporated into the method.

First-three dimensional seismic data is acquired as described above, in step 210.

An initial model of the subsurface 1000 is provided in step 220. The initial model is generally the current best guess of the properties relevant to the propagation of seismic energy at each grid point of a grid covering the subsurface 1000. The initial model includes, for each position of a grid, parameters relating to the geological formation 50, 60, 70, 80, 90 present at the location of the grid point.

In an embodiment each grid point may have more than one parameter associated with it. The parameter(s) associated with each grid point depend upon the type of wave equation and the symmetry of the anisotropy. Usually each grid point will have a density associated with it, plus up to 21 independent elastic moduli, and up to 21 independent anelastic moduli—more if these are themselves frequency dependent (which they are unlikely to be over the range of frequencies that are available). These 43 properties can be combined in various ways to make other dependant properties, for example p-wave velocity, or s-wave velocity, and if the anisotropy has various types of symmetry or is absent entirely, then many of these parameters are not independent. Where a priori rock physics and/or bore hole information is available, combinations of these parameters can be used, together with quantitative measurements on their geometric properties to obtain derived higher-order properties. For example, if the anisotropy in a certain unit is known or assumed to be related to oriented fractures, then the fracture density, aspect ratio, orientation, fluid content, connectivity, and so forth can be constrained. These properties in turn may be related to the state of stress in the rock unit and its strain history.

The parameters except density vary both with propagation direction and with polarisation orientation—that is three waves all travelling in the same direction will potentially travel with three different velocities as their polarisation are in three mutually orthogonal directions. Therefore, these parameters may be modelled as being anisotropic meaning that the parameter is different for different directions. This is particularly relevant for mining applications in that the prediction of anisotropic properties of geological formations 50, 60, 70, 80, 90 can be related to particular physical properties at the grid point such as the presence and direction of fractures.

An initial starting model of the source 120 and sensor 120 locations is provided in step 224. A starting model for the waveforms generated by the source(s) is provided in step 226.

The three dimensional seismic data from step 210, the initial model from step 220, the starting model of source/receiver locations from step 224 and the starting model for the waveforms generated by the source(s) from step 226 are fed to the wavefield tomography step 230. Any type of wavefield tomography may be used.

In overview, in wavefield tomography synthetic seismic data is calculated. In this calculation step the information regarding the sources of the seismic survey (position of sources and sensors and properties of the seismic energy) as well as the initial model are used to predict a forward and backward wavefield between the sources(s) and sensors, given the assumptions in the initial model. The passage of seismic energy in a direct path from a source to a sensor as well as in an indirect path (for example a path in which the energy is reflected one or more times) is calculated. Variations in the speed of the seismic energy through the geological formations 50, 60, 70, 80, 90 and the position of any interfaces between geological formations 50, 60, 70, 80, 90 and thereby the position of reflections all effect the wavefields.

After forward and backward wavefields have been calculated a gradient is determined by comparison of those two wavefields.

The gradient is then used to update the model.

The updated model is then used to generate new forward and backward wavefields which are again compared to generate a new gradient which is used to update the model. The loop is followed until the comparison between the forward and backward wavefield indicates an acceptable degree of match between the synthetic seismic data and the actual seismic data. At this point the wavefield tomography 230 proceeds to step 238 at which a revised model is output.

Examples of techniques used in wavefield tomography are described in, for example, Tarantola, A., (1984) Inversion of seismic reflection data in the acoustic approximation. Geophysics, 49, 1259-1266 which relates to basic acoustic theory; Tarantola, A (1986) A strategy for nonlinear elastic inversion of seismic reflection data. Geophysics, 51, 1893-1903 which relates to basic elastic theory; Mora, P. R. (1987) Nonlinear two-dimensional elastic inversion of multioffset seismic data. Geophysics, 52, 1211-1228 which relates to the beginnings of a practical method; Mora, P. R. (1989) Inversion-migration-tomography. Geophysics, 54, 1575-1586 which parallels with other methodologies; Pratt, R. G., Song, Z.-M., Williamson, P., and Warner, M. (1996) Two-dimensional velocity models from wide-angle seismic data by wavefield inversion. Geophysical Journal International, 124, 323-340 which is a demonstration on surface wide-angle data—synthetic, 2D; Pratt, R. G. (1999) Seismic waveform inversion in the frequency domain, Part 1: Theory and verification in a physical scale model. Geophysics, 64, 888-901 which develops theory in the frequency-domain; Graham J. Hicks and R. Gerhard Pratt (2001) Reflection waveform inversion using local descent methods: Estimating attenuation and velocity over a gas-sand deposit. Geophysics, 66, 598-612 which includes a demonstration for attenuation; Shipp, R. M., and Singh, S. C., (2002) Two-dimensional full wavefield inversion of wide-aperture marine seismic streamer data. Geophysical Journal International, 151, 325-344 which is a time-domain demonstration on field data—2D, elastic; Sirgue L & Pratt R G (2004) Efficient waveform inversion and imaging: A strategy for selecting temporal frequencies. Geophysics, 69, 231-248 which is a further development of the use of the frequency-domain; and Changsoo Shin and Young Ho Cha (2008) Waveform inversion in the Laplace domain. Geophys. J. Int. 173, 922-931 which is a demonstration in Laplace domain. US 2010/0042391 describes wavefield tomography in the Laplace-Fourier domain.

Example details of a computational method of wavefield tomography in step 230 will now be described with reference to the eight stages illustrated in FIG. 2. In the method stages 2-8 are repeated until an acceptable degree of accuracy has been reached.
1. Start from the observed seismic data, a starting model of physical properties, a starting model of source/receiver locations, and a starting model for the waveforms generated by the source. In most cases the source/receiver locations will be known accurately, but they may be included in the inversion—especially if the sources are passive/induced rather than generated deliberately.
2. Pre-process the observed seismic data, and/or transform it into another domain or domains, and/or form composite sources and/or composite receivers by combining sub-sets of data together, and or apply reciprocity to exchange the positions of source and receivers. The pre-processing may include, but is not limited to, changing the temporal and/or spectral and/or spatial amplitudes of the data, adjusting the phase and timing of the data, deconvolving and/or convolving in space and/or time, mixing, windowing, muting, multi-dimensional filtering in space, time, frequency and/or other domains. The pre-processing may be data dependant and/or model dependent and/or deterministic. The total number of sources or composite sources included in each iteration may be greater than, equal to, or less than the number of actual physical sources.
3. For each source (or composite source) that is included in the current iteration, calculate the wavefield within all or part of the current model of physical properties and at one or more receiver (or composite receiver) locations using an appropriate wave equation (examples are given below). The resulting wavefield within the model and at the receiver locations is called the forward wavefield.
4. Apply pre-processing to the calculated forward wavefield at each receiver or composite receiver. This pre-processing need not be identical to that applied to the observed data, and it may be data dependent—on both the calculated and observed data. Compare the pre-processed calculated data with the pre-processed observed data, and extract a new wavefield that results from this comparison at each receiver. At its simplest, this comparison may be a simple point-wise subtraction of the two datasets, but it may involve instead for example the difference between the weighted summed datasets at each receiver, the phase difference between the two wavefields at one or more frequencies, the point-wise difference of their absolute values, the point-wise difference between their envelopes, or other measures of similarity. The result of this comparison maybe further pre-processed, after which, for each source, it forms a wavefield at the receivers that is termed the residual dataset.
5. By considering the receivers (or composite receivers) as sources (or composite sources), propagate the residual wavefield from the receivers backwards in time into the model towards the original source and towards the heterogeneities within the model that generated the forward wavefield. This produces a wavefield within all or part of the model that is termed the backward wavefield. There will be one such backward wavefield and a corresponding forward wavefield for each original source.
6. By comparison of the forward and backward wavefields throughout the model, and by further processing, generate an unsealed update to the original model. This is termed the gradient. The simplest means of generating the gradient is to cross-correlate the forward and backward wavefields in time at every point in the model for every original source, taking the zero-lag of this correlation, and adding together the results from every source. The data used to generate the gradient, and/or the raw gradient, may be weighted spatially and/or smoothed in space and/or convolved and/or deconvolved in space and/or processed in other ways to obtain a modified gradient, and/or the forward and backward wavefields may be pre-processed prior to cross-correlation. The pre-processing of the wavefields, and the processing of the raw gradient may be data and/or model dependant.
7. The gradient is used to perturb the original model in one or more ways. Optionally, new synthetic data are generated using this perturbed model or models. This allows the calculation of further residual datasets. By having regard to the degree to which these new residual datasets compare to the residual datasets calculated at stage 4 and/or to the effect of previous model updates obtained during previous iterations, and/or to the roughness and/or other statistical measures of model heterogeneity, and/or deviation from an a priori starting model, and/or closeness to other known or assumed geometric, statistical, structural or physical property information, an optimal update to the original model is determined. For example, by perturbing the starting model by a small amount in the direction indicated by the gradient, and assuming a linear relationship between changes in data residuals and model perturbation, the total model perturbation required to minimise the least-squares sum of the residuals can be predicted. If required, similar considerations can be applied also to update the source wavefield, and/or source/receiver geometry.
8. Using the model update obtained at stage 7, the original model is updated. The source waveform and/or the source timing and/or the source locations and/or receiver locations may also be updated. The sub-set of data to be inverted, and its pre-processing may be changed, and the process iterated with the new model, new sources and receivers, and new pre-processed observed data, starting the process a new from stage 2. Iteration proceeds until the model updates fall below some satisfactory threshold, or some other predetermined limit is reached, for example the number of iterations or total computer time required.

During calculation of synthetic seismic data (stages 3 and 5), P and/or S waves may be modelled. P-waves can be considered the analogue of sound waves in solids. S-waves are transversely polarised waves that can only exist in solids—not fluids—they involve only a change in shape of the medium not any change in volume. If only the acoustic wave equation is solved, only p-waves are modelled. If the elastic wave equation is solved, both p- and s-waves are modelled. If modest elastic anisotropy is used, the shear-wave speed depends upon polarisation as well as direction of travel—the two shear waves split. If strong elastic anisotropy is used, then the differences between p and s waves can become less clear.

In one embodiment the wavefield tomography includes generating synthetic seismic data by solving an acoustic wave equation.

This is computationally the least demanding approach—fast, inexpensive, less memory and time and fewer processors are required. It appears to be more robust in that it is less likely to generate spurious results. The acoustic wave equation is better understood and hence easier to parameterise. The acoustic wave equation is more straightforward to code. On given hardware, the acoustic wave equation is can use the largest models.

The model used to calculate the synthetic seismic data may solve an acoustic wave equation. The acoustic wave equation is:

$$\frac{1}{{c}^{2}} \frac{{\partial }^{2} p}{\partial {t}^{2}} - ρ ∇ \cdot ( \frac{∇ p}{ρ} ) = s$$

This is written for acoustic pressure p in the time-domain where t is time, c is the acoustic wave speed, ρ is density, s is the acoustic source function in space and time, and ∇ is the del operator in three dimensions. c and ρ are functions of position, and p is a function of time and position.

To solve this in the time domain by explicit finite-differences, using a regular rectangular mesh in space, and at regular steps in time. The differential operators are replaced by finite difference operators. The solution proceeds by stepping the solution forward in time. Because the solution at every point on the mesh is known at earlier times, solution at the next time step can be calculated by applying the wave equation approximated by finite differences. The method is long-established, and there are many variations of detail.

In the frequency domain, the analogous equation is

$$\frac{{ω}^{2}}{{c}^{2}} P + ρ ∇ \cdot ( \frac{∇ p}{ρ} ) = - S$$

where P and S are the temporal Fourier transforms of p and s, and ω is frequency.

In this case, when a finite difference approximation is applied to the spatial operator, a set of large, sparse matrix equations, one equation for each frequency, is derived. These can either be solved by direct factorisation, but in 3D this has large memory requirements which make it impractical for large models, or by iterating from an approximate solution. The latter has much smaller memory requirements for large models.

In one embodiment the wavefield tomography includes generating synthetic seismic data by solving an elastic wave equation.

This emulates the physics of seismic wave propagation more accurately than does the acoustic wave equation. It calculates wave amplitudes more accurately, and so can extract more information from a given dataset. It can determine shear-wave properties. It can determine density with less uncertainty than acoustic methods. It can deal with fluid properties within pore space more accurately. In principle, it therefore provides more accurate models for a wider range of properties than does the acoustic wave equation. The computational cost however is more than ten times as much, and may be up to 100 times as much in some circumstances.

The model used to calculate the synthetic seismic data may solve an elastic wave equation. The elastic wave equation can be written in many forms; one such in the time domain is:

ρ∂ₜ\dot{u}=∂ₓτₓₓ+∂_{y}τ_{xy}+∂_{z}τ_{xz}

ρ∂ₜ\dot{v}=∂ₓτ_{xy}+∂_{y}τ_{yy}+∂_{z}τ_{yz}

ρ∂ₜ\dot{w}=∂ₓτ_{xz}+∂_{y}τ_{yz}+∂_{z}τ_{zz}

∂ₜτₓₓ=(λ+2μ)∂ₓ\dot{u}+λ(∂_{y}\dot{v}+∂_{z}\dot{w})

∂ₜτ_{yy}=(λ+2μ)∂_{y}\dot{v}+λ(∂ₓ\dot{u}+∂_{z}\dot{w})

∂ₜτ_{zz}=(λ+2μ)∂_{z}\dot{w}+λ(∂ₓ\dot{u}+∂_{y}\dot{v})

∂ₜτ_{xy}=2μ(∂_{y}\dot{u}+∂ₓ\dot{v})

∂ₜτ_{xz}=2μ(∂_{z}\dot{u}+∂ₓ\dot{w})

∂ₜτ_{yz}=2μ(∂_{z}\dot{v}+∂_{y}\dot{w})

Here ρ is density, μ is the shear modulus, and λ is the second Lame parameter. The differential operators operate in time ∂ₜ, and in three space directions, ∂ₓ, ∂_{y} and ∂_{z}. The six independent components of stress are given by τ, where the superscripts refer to the orientation of the component—thus τₓₓ is a normal component of stress in the x-direction, and τ_{xy} is a shear component of stress in the y-direction over a plane perpendicular to the x-direction, and τ_{xy}=τ_{yx}, and \dot{u}, \dot{v} and \dot{w} are particle velocity in the three space directions.

The equation is typically solved by explicit time stepping in the time domain in a way that is analogous to the acoustic wave equation. Typically however the stresses and particle velocities are solved on different meshes that are staggered by have a cell in space and by half a time step in time.

In one embodiment the wavefield tomography includes generating synthetic seismic data by solving a visco-acoustic wave equation.

This allows the proper incorporation of anelastic losses (i.e. attenuation) into the algorithm. This models amplitudes more accurately than does the acoustic wave equation. It allows the extraction of anelastic properties which in turn relate to fracturing, sub-seismic-wavelength-scale heterogeneity, fluid content and state of stress which are important in mining applications.

The model used to calculate the synthetic seismic data may solve a visco-acoustic wave equation. In the frequency domain, the viscose-acoustic wave equation is identical to the acoustic wave equation with the addition that the acoustic velocity c becomes complex, where the real part of c represents a velocity and the imaginary part is related to the Q-factor which in turn relates to the attenuation. The resulting equations are solved identically to those for the acoustic wave equation, but the velocity is complex throughout.

In the time domain, the equation involves the solution of an integral over frequency at every time step. This is a computationally expensive operation, and various approximations to it may be used in order to speed up the computation.

In one embodiment the wavefield tomography includes generating synthetic seismic data by solving a visco-elastic wave equation

This combines the advantages of elastic and visco-acoustic above. It provides a proper account of amplitudes. It can recover shear-wave anelastic properties. It can recover p-wave an-elastic properties with more certainty and accuracy. However, it is the most expensive approach, and least robust.

The model used to calculate the synthetic seismic data may solve an visco-elastic wave equation. This equation is similar to the elastic equation, but it contains additional terms that control the attenuation. The equation is expensive to solve, and various approximations to it can be made in order to speed up the computation. The appropriate approximation depends upon the model of attenuation that is assumed, and is only generally accurate over a limited bandwidth.

The equation is typically solved by explicit time stepping.

Whichever wave equation(s) are solved in the model, the equations may include parameters which are anisotropic. In this case, the speed of propagation of a wave depends upon both its direction of propagation and its direction of polarisation. In strongly anisotropic media, the distinction between p and s-waves becomes blurred, with waves typically manifesting intermediate properties.

Preferably the wave equation solved in generating synthetic seismic data accounts for anisotropic properties of the medium through which the wave propagates. In particular, estimating the anisotropic properties of the deposit can provide information relating to oriented meso and micro-structure, for example fractures, faults, joints, folds, foliations, laminations, layering, bedding, pore space, state of stress, and mineral orientation and alignment, which may in turn influence rock-mechanical properties. Particularly for block cave mining information regarding fractures and mechanical properties of the deposits can be useful in aiding mine design and extraction of the deposits.

In the most general, elastic, anisotropic medium, each grid cell is characterised by 21 independent elastic moduli that each relate one component of stress, to one component of strain, plus density. If this general medium is also anisotropic and an-elastic, a further 21 independent moduli are required to describe the anisotropic attenuation.

Anisotropic media can locally display various degrees of symmetry. Such symmetry reduces the number independent moduli. For example, if a purely elastic medium displays local rotational symmetry about a vertical axis, then five moduli plus density are adequate to describe the medium at each grid point.

Anisotropy is of particular importance in mining applications because many properties of interest lead to anisotropy in elastic and an-elastic properties. The orientation and aspect ratios of fractures, faults and joints, and the micro and meso structure of folds, laminations, foliations, lineations, bedding and other layering, and mineral and pore-space alignment and orientation all affect anisotropy and all can be related to mechanical and other physical properties in geological formations 50, 60, 70, 80, 900.

Therefore, including elasticity, anelasticity and anisotropy into the wave equation gives more parameters for each grid point, and this can increase the achievable resolution, and increase the volume of usable information that can be extracted from the data. In the simplest form of elliptical acoustic anisotropy, two rather than one elastic parameter can be extracted at every grid point. At its most general, a fully visco-elastic formulation with arbitrary anisotropy will in principle allow 43 independent, frequency-independent, parameters to be extracted at each grid point, or an arbitrarily large number if these properties vary with frequency.

In one embodiment the wavefield tomography is at least partly implemented in the time domain. In one embodiment the wavefield tomography is at least partly implemented in the frequency domain. In one embodiment the wavefield tomography is at least partly implemented in the Laplace domain. The wave equation is transformed into the particular domain chosen, and solved it there—the modelling, the observed data, the processing, is done in that new domain. In a hybrid method parts are performed in one domain and other parts in another domain, either to save some computational effort of because particular steps are more effective in one domain than another. In principle, the transforms that are used to go from one domain to another are reversible, so, apart from the cost of the transform it is possible to move between domains at any point in the computation.

The wavefield tomography may at least be partly implemented in the time domain, and/or the frequency domain, and/or the Laplace domain.

Principal considerations that determine which domain to use are accuracy, speed of computation, ease and type of computational parallelisation, amount of memory required per processor, total memory required, ease of quality control, stability, sensitivity of the results to noise in the input data, to inaccuracies in the starting model, to inaccuracies in the geometry and/or source waveform, and to sparse and missing data, and whether elastic, anisotropic and/or anisotropic effects are to be included. In general, the frequency domain is fastest and allows easy implementation of anelasticity, the time domain is most robust against noise and data sparsity, is easiest to QC, and is straightforward to parallelise on simple hardware, and the Laplace domain is most robust against inadequacies in the starting model. Hybrid methods, in which the synthetic data are computed in one domain, but the tomography is undertaken in another domain (e.g. U.S. Pat. No. 7,725,266), or in which different domains are used in different iterations or on different parts of the model or data, attempt to combine the advantages of more than one domain, or overcome specific limitations of one domain.

The revised model produced in step 238 is a model of the subsurface in which each grid point is assigned parameters according to the updated model. These parameters are indicative of properties of the subsurface at the location of the grid point and can be used to determine an estimate of a property of interest in step 240. The property of interest may be property of a deposit 50 and/or a property of a geological formation 60, 70, 80, 90 and/or may be a property indicative of what type of geological formation is present at the grid point.

In one embodiment the synthetic seismic data (e.g. stage 3 and 5) is calculated using a finite difference method. Finite-difference formulations are generally the fastest, the simplest to program and QC, and require the least memory. They are straightforward to optimise and to parallelise, and their performance and limitations are well understood under a wide variety of conditions.

In an embodiment the synthetic seismic data is calculated using a finite element method. Finite-element formulations are able to match the geometry of complicated boundaries explicitly, and can provide a more accurate result in highly heterogeneous systems. Where physical properties change by large ratios, finite-element formulations can prove more efficient than finite-difference codes because they can be optimised more easily to local model properties, whereas finite-difference codes are only easily optimised to average or extremal global model properties.

In one embodiment the synthetic seismic data is calculated using spectral elements. Spectral element methods can be accurate in models with coarser mesh sizes than other methods, which can lead to savings in memory and computational effort. In the right circumstances, they can provide the most accurate method. In highly heterogeneous models however, their accuracy is difficult to quantify.

If a mine is present in the subsurface, the initial model may contain grid points at which a macroscopic cavity is present in real life. Therefore, during calculation of the synthetic seismic data, the wavefield tomography includes modelling at least one macroscopic cavity in the subsurface.

In one embodiment the initial model includes a non-planar top surface 10 of the subsurface 1000. This is particularly likely to be present in mining applications because deposits of interest are often found in hilly areas. Therefore, the wavefield tomography includes modelling of a non-planar upper surface 10 of the subsurface 1000.

The current finite difference methods used in wavefield tomography typically require a regular mesh. Therefore, currently the surface of the earth is usually modelled as a horizontal surface. If contours are present on the surface of the earth it would in theory be possible to distort the co-ordinate system or to provide steps. However, providing steps can result in diffraction effects from the rough surface interface if the steps are made too large. Making the steps smaller is not feasible because of the increase in computation time this would require. An alternative method which has been discussed is to fill some of the cells of the finite difference grid with gas (e.g. with a different physical parameter). However, this is computationally expensive or inaccurate because of the need for cells with different physical parameters requiring different cell sizes.

Preferably the wavefield tomography includes modelling at least one macroscopic cavity on or in the subsurface. The macroscopic cavity may, for example, be a cavity formed during mining activities. Taking account of the presence of a macroscopic cavity in the subsurface (which might be present in the initial model) is unique to mining applications in that no macroscopic cavities are present or at least are not modelled as being present in hydrocarbon applications. In hydrocarbon applications microscopic pore space may be present, but this is different to macroscopic cavities which are much larger and are due to missing material (e.g. a void be it manmade e.g. by drilling, excavating, etc. or natural) rather than microsized pores in a material. The presence of a macroscopic cavity may have a large effect on the seismic energy from the source(s) so that modelling its presence may greatly enhance the accuracy of the model.

Preferably the wavefield tomography includes modelling a non-planar upper surface of the subsurface. That is, the topography of the land, such as valleys and mountains are accounted for in the wavefield tomography. For oil exploration activities, a planar (flat) top surface to the subsurface is assumed. A non-planar upper surface can be accomplished, even when using a regular grid, by forcing values at grid points on a side of a surface opposite to the subsurface to a value such that the value at the surface is equal to a predetermined value. In this way a regular grid can be used whilst the non-planar upper surface of the subsurface can successfully be modelled without deforming the grid. This has advantages in mining applications because mines are often located in/near hilly regions and/or deep mines and block caves are often located beneath existing surface mines that have previously generated extreme surface topography.

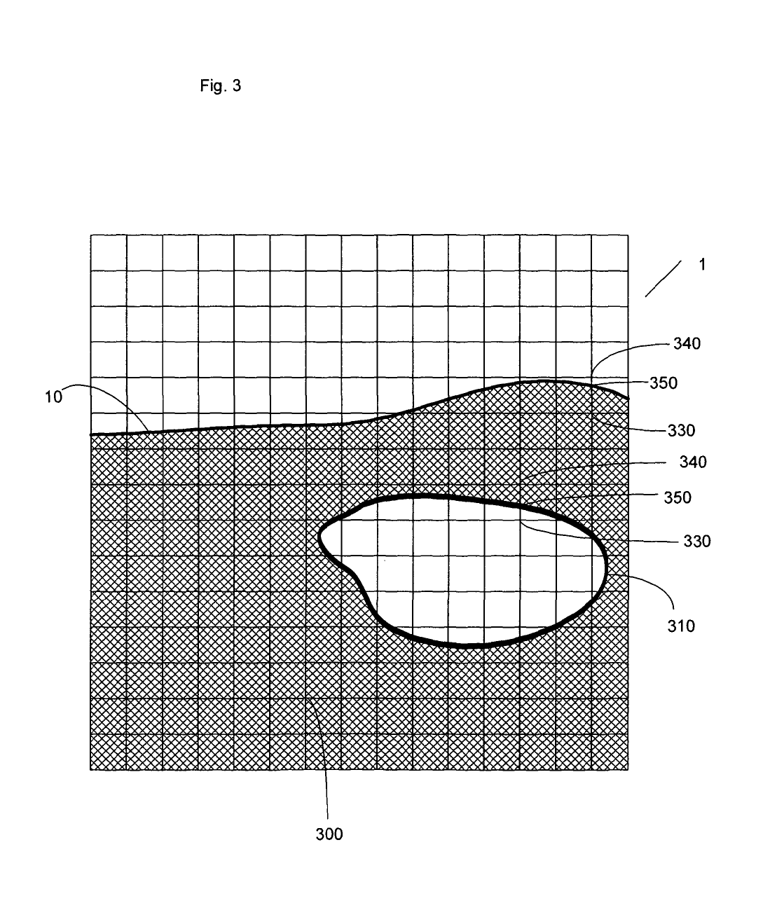

FIG. 3 illustrates how the presence of macroscopic cavities and/or a non-planar upper surface 10 of the subsurface 1000 can be modelled, for example in the finite difference method, whilst maintaining a regular grid. The same principles can be used in a finite element or spectral element method.

FIG. 3 is a two dimensional representation of grid points of a model (initial or otherwise) of the subsurface 1000. The separate geological formations are not shown, for clarity. The same principles can be applied to a three dimensional grid.

One way of dealing with a macroscopic cavity in the subsurface is, during calculation of a synthetic seismic data, to force values at a grid point in the macroscopic cavity to be a value such that the value at a surface of the macroscopic cavity is equal to a predetermined value. This is advantageous because the use of a regular grid during calculation of a synthetic seismic data is preferable (particularly for the finite difference method) and this is one way in which a regular grid can be used whilst a (complexly shaped) macroscopic cavity can be modelled, as is preferable in mining applications. This is because the interaction of the seismic energy with the free surface of the macroscopic cavity could have a large bearing on the seismic data. Microscopic cavities do not effect the seismic data in the same way.

During calculation of synthetic seismic data, a value for seismic energy at each grid point 300 in the subsurface 1000 is calculated. The boundary between a geological formation and a top surface 10 of the subsurface 1 or an internal surface 310 of a macroscopic cavity in the subsurface 1000 is modelled as follows. The value of the parameters at a grid point 330 on the other side of the surface 10 and surface 310 of the macroscopic cavity to the geological formation have values forced upon them such that an interpolation of the seismic energy between an adjacent grid point 340 on the side of the surface 10, 310 in the geological formation and the grid point 330, results in the parameter having a predetermined value (for example zero) at the position 350 of the surface 10, 310 between the two grid points 330, 340. This allows use of a regular grid (regular spacing of grid points) whilst allowing to model closely the shape of the surface 10, 310 without needing to reduce the grid spacing which would deleteriously effect the time it takes to calculate a synthetic seismic data.

Preferably, the subsurface includes a block caving mine, a deep mine and/or a surface mine. This allows the technique to be used in the mine design, and/or its evaluation and/or the extraction of deposits from the mine. In the case of a block mine, the seismic data may include as a source an explosion used as part of building of the block mine. This is particularly efficient as the explosion is used for two purposes. Because a source is positioned directly at or close to the deposit, this increases the achievable resolution for the properties of the deposit.

By modelling a macroscopic cavity in the wavefield tomography 230, it is possible to model the presence of a block caving mine, a deep mine and even a surface mine. Therefore, the seismic survey may be of a subsurface 1000 including such a mine within the subsurface or at the surface 10 of the subsurface 1000. This method allows the wavefield tomography to model synthetic seismic data in which the source is an explosion used as part of building of the block mine/excavation from the block mine.

The present invention may be implemented on a computing apparatus comprising a computing device, a bus system, a storage unit communicating with the computing device over the bus system and on which an application resides. The application can execute the above mentioned method.

The present invention is also a computer program for example stored on a computer readable medium which stores instructions which, when executed on a computer, perform the above described method.

1. A method to aid in the exploration, mine design, evaluation and/or extraction of metalliferous mineral and/or diamond deposits in a subsurface, the method comprising:
providing three-dimensional seismic data acquired in a seismic survey of the subsurface;
providing an initial model of the subsurface;
performing wavefield tomography at least partly as a function of at least one property of the subsurface in three-dimensions using the initial model and the seismic data to generate an updated model; and
determining an estimate of the at least one property of the subsurface from the updated model.

2. The method of claim 1, wherein the at least one property comprises at least one property selected from the group comprising: the location of a deposit or other geological formation, the mechanical, elastic, anelastic and anisotropic properties of deposits and other geological formations within the subsurface, the intensity, scale, orientation and detailed character and geometry of fracturing, faulting, jointing, micro-cracking, folding, lineation, foliation, lamination, layering, bedding and heterogeneity of deposits and other geological formations within the subsurface, and the density, porosity, pore geometry, fluid content, fluid pressure, mineral alignment, mineral orientation, and state of stress of deposits and other geological formations within the subsurface.

3. The method of claim 1, wherein the three-dimensional seismic data is generated by at least one source and/or at least one receiver in the subsurface, preferably by at least one source and/or at least one receiver in a mine in the subsurface.

4. The method of claim 3, wherein a plurality of sources and/or a plurality of receivers are in a multi-dimensional array in the subsurface.

5. The method of claim 4, wherein the multi-dimensional array in the subsurface is a multi-dimensional array substantially in a plane.

6. The method of claim 1, wherein the wavefield tomography includes modelling at least one macroscopic cavity in the subsurface.

7. The method of claim 6, wherein the wavefield tomography comprises, during calculation of a synthetic seismic data using a regular grid, forcing values at a grid point in the macroscopic cavity to be a value such that the value at a surface of the macroscopic cavity is equal to a predetermined value.

8. The method of claim 1, wherein the wavefield tomography includes modelling a non-planar upper surface of the subsurface, preferably wherein the wavefield tomography comprises, during calculation of a synthetic seismic data using a regular grid, forcing values at a grid point on a side of the surface opposite to the subsurface to be a value such that the value at the surface is equal to a predetermined value.

9. (canceled)

10. The method of claim 7, wherein the predetermined value of pressure at the surface is zero.

11. The method of claim 1, wherein the subsurface includes one or more selected from the group consisting of a block caving mine, a deep mine, and a surface mine.

12. The method of claim 11, wherein the seismic data includes as a source an explosion used as part of building of/excavation from the block mine.

13. (canceled)

14. (canceled)

15. The method of claim 1, wherein the wavefield tomography is at least partly implemented in one selected from the group consisting of the time domain, the frequency domain, and the Laplace domain.

16. (canceled)

17. (canceled)

18. The method of claim 1, wherein the wavefield tomography includes generating synthetic seismic data.

19. The method of claim 18, wherein the synthetic seismic data is generated by solving one selected from the group consisting of an acoustic wave equation, an elastic wave equation, a visco-acoustic wave equation, and a visco-elastic wave equation.

20. (canceled)

21. (canceled)

22. (canceled)

23. The method of claim 1, wherein the wave equation solved in generating synthetic seismic data accounts for anisotropic properties of the medium through which the wave propagates.

24. The method of claim 18, wherein the wave equation solved in generating synthetic seismic data includes terms to account for at least one selected from the group comprising: elasticity, an elasticity, anisotropy.

25. The method of claim 18, wherein the synthetic seismic data is generated using one selected from the group consisting of finite differences, finite elements, and spectral elements.

26. (canceled)

27. (canceled)

28. A method of collecting seismic data, comprising using a plurality of receivers to record seismic waves resulting from explosions used in block caving to build a block caving mine.

29. A method to aid in the exploration, mine design, evaluation and/or extraction of metalliferous mineral and/or diamond deposits in a subsurface, the method comprising providing an initial model of the subsurface; using the data collected by the method of claim 28 in wavefield tomography along with the initial model to generate an updated model; and determining an estimate of at least one property of the subsurface from the updated model.

30. A computing apparatus, comprising:
a computing device;
a bus system;
a storage unit communicating with the computing device over the bus system;
an application residing on the storage unit that, when executed on the computing device, performs the method of claim 1.

31. (canceled)

32. (canceled)

33. (canceled)

34. (canceled)

35. (canceled)
